(19) United States
(12) Patent Application Publication
(10) Pub. No.: US 2011/0120160 A1
(43) Pub. Date: May 26, 2011

(54) System For Controlling An Air-Conditioning System

(76) Inventor: GUNNAR DIETRICH, MANNHEIM (DE)

(21) Appl. No.: 12/779,261

(22) Filed: May 13, 2010

(30) Foreign Application Priority Data
Jul. 3, 2009 (DE) 10 2009 027 458.8

(51) Int. Cl. B60H 1/32; F25B 49/02

(52) U.S. Cl. 62/133; 62/228.1

(57) ABSTRACT

A control system controls a vehicle air-conditioning system including a cooling circuit having a compressor with a refrigerant that is supplemented with a compressor lubricant. The control system includes a control unit which controls the drive torque used for starting up the compressor. The control unit reduces the drive torque as a function of a determined time parameter that represents an elapsed compressor stoppage time (ΔT).

### FIELD OF THE INVENTION

The invention relates to a control system for controlling an air-conditioning system of a motor vehicle.

### BACKGROUND OF THE INVENTION

Such a system for controlling an air-conditioning system for a motor vehicle is shown in German patent no. 199 38 927 C1. The system comprises a cooling circuit as well as a condenser or compressor arranged therein. The compressor is driven by a combustion engine located in the motor vehicle. A electrically operated compressor clutch is connected between the engine and the compressor. The compressor clutch is connected to an electrical switch by means of which the compressor clutch can be engaged for starting up the compressor. For lubricating the compressor, the refrigerant in the cooling circuit is supplemented with a suitable lubricant. For longer compressor stoppage times, the lubricant may settle in the cooling circuit and separate from the coolant. Thus, during start-up, the compressor may initially run with reduced lubrication until lubricant is led out from the cooling circuit to the compressor. Under unfavorable conditions, this can lead to damage or premature wear on the compressor. The known system therefore has a timing controller that sets the compressor in operation independent of the current activation state of the switch in the warming-up phase of the combustion engine by engaging the compressor clutch for a specified time span. Because the compressor clutch engages according to a fixed time sequence, the actual degree of separation of the refrigerant and the lubricant remains unconsidered. Therefore, even for longer compressor stoppage times, the compressor may be exposed to relatively high loads during the warming-up phase.

### SUMMARY

Accordingly, an object of this invention is to provide a control system for an air conditioning system which guarantees an especially gentle or low-wear start-up of the compressor.

A further object of the invention is to provide such a control system which guarantees an especially gentle or low-wear start-up of the compressor in the case of longer compressor stoppage times.

These and other objects are achieved by the present invention, wherein a control system controls an air-conditioning system of a motor vehicle. The vehicle may be an agricultural utility vehicle such as a tractor or the like. The control system includes a cooling circuit operated by a compressor with a refrigerant that is supplemented with a lubricant for lubricating the compressor. A drive torque applied for starting up the compressor is reduced by means of a controller according to a determined time parameter that represents an elapsed compressor stoppage time.

Because the degree of separation of the refrigerant and the lubricant is directly dependent on the elapsed compressor stoppage time, through corresponding reduction of the drive torque according to the determined time parameter, an especially gentle and low-wear start-up of the compressor can be guaranteed.

Advantageously, by evaluating the determined time parameter, the controller reduces the drive torque applied for starting up the compressor, when it is found that the elapsed compressor stoppage time exceeds a specified threshold. The threshold can be specified according to the characteristic settling tendency of the lubricant in use and can lie on the order of magnitude of several weeks or months. As a rule, commercially available R134A is used as the refrigerant, and a refrigerant oil, for example, PAG oil (polyalkylene glycol), is used as the lubricant.

To allow a targeted influence on the drive torque, a compressor clutch that can be activated electrically can be arranged between the compressor and the drive assembly, wherein the engagement of this clutch can be adjusted on the part of the controller. The drive assembly involves, in particular, a combustion engine that is located in the motor vehicle and that connects via a drive belt to a belt pulley allocated to the compressor clutch. The engagement is controlled by means of an electromagnetic adjusting system that is part of the clutch and that is controlled on the part of the controller by means of an intermediate power regulator. Alternatively, it is also possible to drive the compressor without an intermediate compressor clutch through the use of an electric motor, wherein the drive torque can be influenced selectively by changing the current draw of the electric motor.

The controller determines the time parameter advantageously on the basis of time information detected in direct or indirect relation with the preceding start-up of the compressor. The time information in the form of a time stamp can be read into a memory allocated to the controller, wherein the time stamp is generated when a starter provided for starting the combustion engine is activated. The time stamp comprises, in particular, information with respect to date and time of the starter activation.

For providing the time information, an electronic time basis can be provided that is connected to the controller via a CAN data bus. Because such an electronic time basis is already provided in many motor vehicles as a component of an onboard computer, the conversion or retrofitting of the system according to the invention is possible with relatively low expense.

### BRIEF DESCRIPTION OF THE DRAWINGS

FIG. 1 is a schematic diagram of a control system according to the invention; and

FIG. 2 is a flow chart of an algorithm executed by the control system of FIG. 1.

### DESCRIPTION OF THE PREFERRED EMBODIMENT

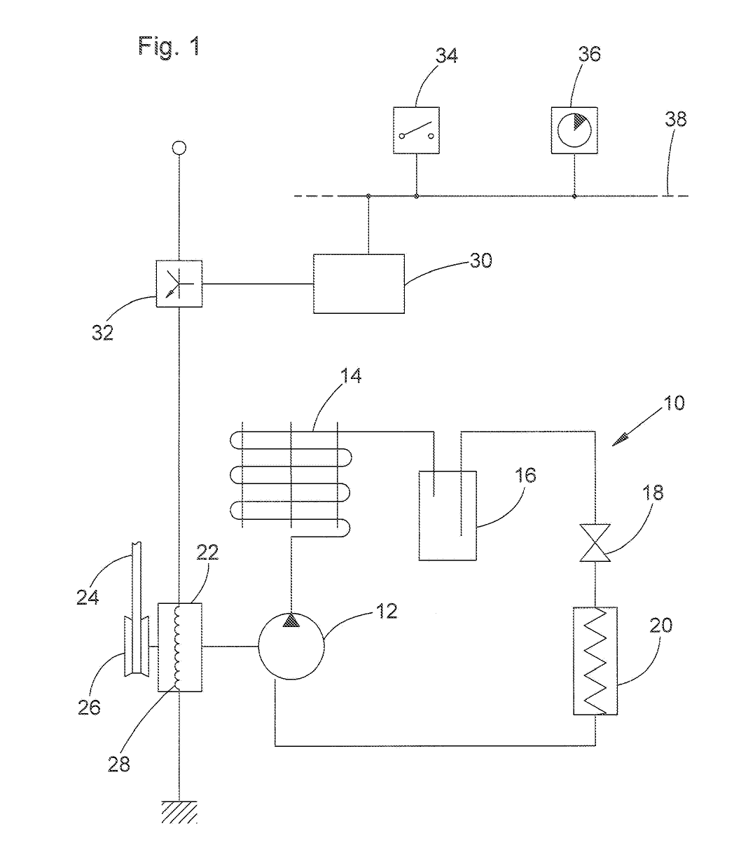

Referring to FIG. 1, the air-conditioning system 10 has a conventional structural type and includes a cooling circuit with a compressor 12 for compressing a refrigerant circulating in the cooling circuit, wherein a suitable lubricant is added to this refrigerant for lubricating the compressor 12. The air-conditioning system further comprises a condenser 14 carrying an air flow, a liquid separator 16, a decompression valve 18, and an evaporator 20. Preferably, for example, commercially available R134A is used as the refrigerant, and a refrigerant oil, in particular, PAG oil (polyalkylene glycol), is used as the lubricant.

The compressor 12 is driven by a compressor clutch or clutch 22 which is driven by a belt pulley 26 which is driven by a belt 24 which is driven by an internal combustion engine (not shown). The clutch 22 can be activated electrically and whose engagement can be adjusted for the targeted influence of a drive torque used for starting up the compressor 12.

The variable engagement of the clutch 22 is controlled by an electromagnetic element 28 that is part of the clutch 22, which is controlled by controller or control unit 30 which is connected to element 28 by an intermediate power regulator 32. For controlling the electromagnetic element 28, the controller 30 evaluates, on one hand, the current activation state of a circuit element or switch 34 provided for the driver-side starting and/or for the selection of an automated operation of the air-conditioning system 10, as well as time information provided on the part of an electronic timer 36, wherein both the circuit element 34 and also the timer 36 are connected to the controller 30 by means of a CAN data bus 38 located in the motor vehicle.

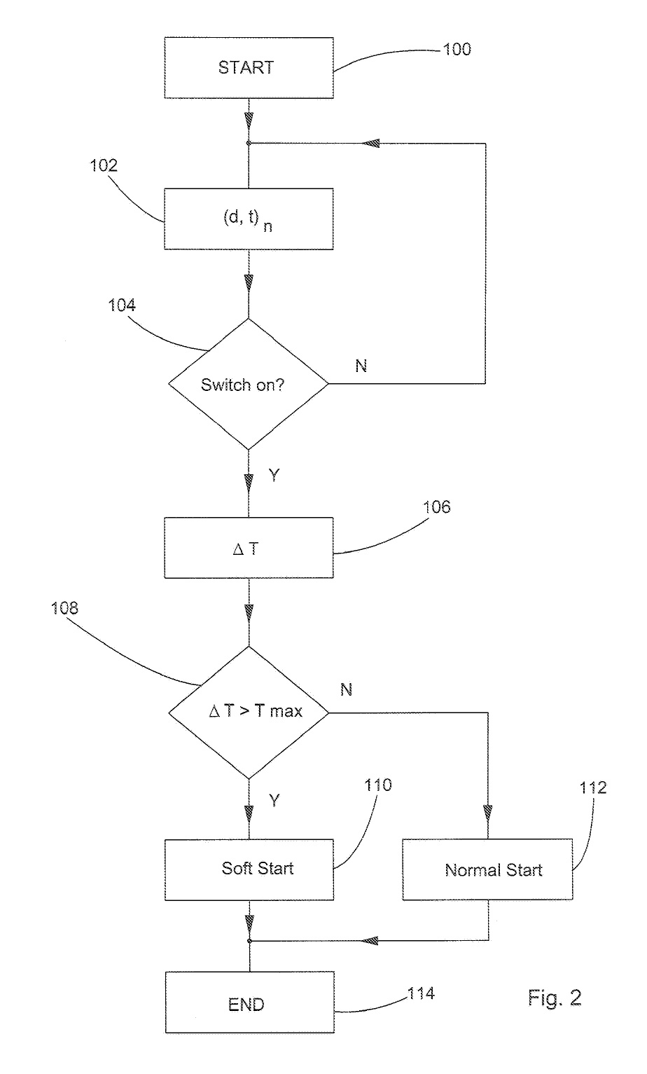

The control unit 30 executes a control algorithm or method illustrated by the flow chart of FIG. 2. Initialization step 100 is performed when an engine starter (not shown) is activated. In step 102, on the basis of the time information provided by timer 36, a time stamp (d, t)n is generated that comprises information with respect to date and time of the starter activation. The time information generated in this way is then stored in a memory in the controller 30 and is then available for further processing with a time stamp (d, t)n−1 read in during a subsequent starter activation.

In step 104, by evaluating the activation state of the switch 34, the controller 30 checks whether a driver commanded start-up of the air-conditioning system 10 is intended and/or its automated operation is selected. If this is not the case, then a possibly present compressor operation is interrupted by disengaging the clutch 22 and the algorithm returns to step 102. In contrast, if it is found in step 104 that a driver commanded start-up of the air-conditioning system 10 is intended and/or its automated operation is selected, then processing continues with step 106.

In step 106, on the basis of a comparison performed between the two time stamps (d, t)n−1 and (d, t)n, the controller 30 determines a time that represents a compressor stoppage time ΔT elapsed between the two consecutive starter activations n and n−1.

In step 108, by evaluating the determined time parameter, if the controller 30 determines that the elapsed compressor stoppage time ΔT exceeds a threshold Tmax on the order of magnitude of several weeks or months specified according to the characteristic settling tendency of the lubricant in use, then in step 110, the engagement of the clutch 22 is adjusted by suitable control of the electromagnetic element 28 so that the compressor 12 is loaded for a “soft start” only with a part of the available drive torque from the engine (not shown). In this respect, the drive torque used for starting up the compressor 12 is reduced according to the determined time parameter. Then the engagement of the clutch 22 is increased continuously within a time span provided for this purpose until a value provided for normal operation is reached. The time span is directed according to the compressor run time needed for mixing the refrigerant and the lubricant and will be on the order of from 30 seconds up to a few minutes. In this way, an especially gentle and low-wear start-up of the compressor 12 is guaranteed in the case of longer compressor stoppage times. The algorithm ends at step 114.

If the controller 30 determines, by evaluating the determined time parameter in step 108, that the elapsed compressor stoppage time ΔT does not exceed the specified threshold Tmax, then the engagement of the compressor clutch 22 is increased in step 112 immediately to the value provided for normal operation (“normal start”). Then the algorithm is ended at step 114.

While the present invention has been described in conjunction with a specific embodiment, it is understood that many alternatives, modifications and variations will be apparent to those skilled in the art in light of the foregoing description. Accordingly, this invention is intended to embrace all such alternatives, modifications and variations which fall within the spirit and scope of the appended claims.

I claim:

1. In a vehicle air-conditioning system having a cooling circuit with an engine-driven compressor having a refrigerant which is supplemented with a compressor lubricant, characterized by:
a control unit generating a torque control signal as a function of a determined time parameter that represents an elapsed compressor stoppage time (ΔT); and
a torque controller for controlling a drive torque transmitted to the compressor in response to the torque control signal.

2. The air-conditioning system of claim 1, wherein:
the control unit evaluates the determined time parameter, and reduces the drive torque used for starting up the compressor, when the elapsed compressor stoppage time (ΔT) exceeds a specified threshold value (Tmax).

3. The air-conditioning system of claim 1, wherein:
the torque controller comprises an electrically operated clutch between the compressor and the engine, and engagement of the clutch is controlled to vary drive torque transmitted to the compressor.

4. The air-conditioning system of claim 1, wherein:
the control unit determines the time parameter on the basis of time information detected in relation with a preceding start-up of the compressor.

5. The air-conditioning system of claim 1, wherein:
the time information is provided by an electronic timer which is connected to the control unit via a CAN data bus.
